(19) United States
(12) Patent Application Publication
(10) Pub. No.: US 2006/0192900 A1
(43) Pub. Date: Aug. 31, 2006

(54) Liquid crystal display

(76) Inventors: Kuei-Sheng Tseng, Bade City (TW); Hsu-Ping Tseng, Hsinchu City (TW); Chung-Jen Cheng Chiang, Ji-an Township (TW)

Correspondence Address: RABIN & Berdo, PC, 1101 14TH STREET, NW, SUITE 500, WASHINGTON, DC, 20005, US

(21) Appl. No.: 11/192,030

(22) Filed: Jul. 29, 2005

(30) Foreign Application Priority Data
Feb. 25, 2005 (TW) 94105957

(51) Int. Cl. H04N 5/74; G02F 1/00

(52) U.S. Cl. 348/751

(57) ABSTRACT

A liquid crystal display includes a first substrate, a second substrate and a liquid crystal layer. The first substrate includes an active matrix, a control switch, a pixel electrode and a protrusion. The active matrix includes a number of pixels. Each pixel is defined by a first scan line, a second scan line, a first data line and a second data line. The control switch is disposed inside the pixel and electrically connected with the first scan line and the first data line. The pixel electrode is disposed inside the pixel and electrically connected with the control switch. The protrusion is substantially disposed between the pixel electrode and the first data line. The second substrate is disposed above the first substrate. The liquid crystal layer is disposed between the first substrate and the second substrate.

This application claims the benefit of Taiwan application Serial No. 094105957, filed Feb. 25, 2005, the subject matter of which is incorporated herein by reference.

### BACKGROUND OF THE INVENTION

1. Field of the Invention

The invention relates in general to a liquid crystal display, and more particularly to a liquid crystal display for avoiding light leakage when the liquid crystal display is improperly assembled or is applied to a lateral shear stress.

2. Description of the Related Art

Please referring both FIG. 1A and FIG. 1B, FIG. 1A illustrates part of an electrical circuit layout of a conventional liquid crystal display, and FIG. 1B illustrates part of an enlarged cross-sectional view of the liquid crystal display taken along the line 1B-1B′. In FIG. 1A˜1B, a liquid crystal display 10 includes a thin film transistor substrate 11, a color filter substrate 12 and a liquid crystal layer 13. The crystal layer 13 having a number of liquid crystal molecules 13a is disposed between the thin film transistor substrate 11 and the color filter substrate 12. The thin film transistor substrate 11 includes the first base 11a, an active matrix 14, at least a thin film transistor 15 and at least an indium tin oxide (ITO) pixel electrode 16. The active matrix 14 is disposed on the first base 11a and includes at least a pixel P3. The pixel P3 is defined by the first scan line S3 and the adjacent second scan line S4 crossing with the first data line D3 and the adjacent second data line D4. The thin film transistor 15 is disposed on the first base 11a and inside the pixel P3. The thin film transistor 15 is electrically connected with the first scan line S3 and the first data line D3. The ITO pixel electrode 16 is disposed on the base 11a and inside the pixel P3. The ITO pixel electrode 16 is electrically connected with the thin film transistor 15. The non-uniformity of the image color (mura) in the liquid crystal display 10 is resulted from the electrically coupling effect between the ITO pixel electrode 16 and the first data line D3 or between the ITO pixel electrode 16 and the second data line D4. To avoid the electrically coupling effect, the ITO pixel electrode 16 is in a proper distance from the first data line D3 and the second data line D4, as shown in FIG. 1A.

Please referring to FIG. 1B, the color filter substrate 12 is disposed above the thin film transistor substrate 11 and includes the second base 12a, a black matrix 17, a color filter 18 and an ITO common electrode 19. The black matrix 17 disposed on the second base 12a corresponds to the active matrix 14 and exposes a main portion of the ITO pixel electrode 16. The color filter 18 is disposed on the second base 12a. A peripheral of the color filter 18 covers that of the black matrix 17. The color filter 18 corresponds to the main portion of the ITO pixel electrode 16 exposed by the black matrix 17. The ITO common electrode 19 is disposed on the color filter 18 and the black matrix 17, for generating an electric field along with the ITO pixel electrode 16 to control the orientation of the liquid crystal molecules 13a.

However, as shown in FIG. 1C, when the thin film transistor substrate 11 and the color filter substrate 12 is improperly assembled or a lateral shear stress (such as a lateral shear stress along the X-coordinate) is applied thereto, a relative displacement occurs between the thin film transistor substrate 11 and the color filter substrate 12. Even if the black matrix 17 can cover part of the area between the ITO pixel electrode 16 and the first data line D3, light leaks in the liquid crystal display 10 because the arrangement of the liquid molecules 13a in this area can still change the phase or the polarization direction of the incident light L. Therefore, the aperture ratio of the liquid crystal display 10 is decreased seriously, and the range of the view angle of the liquid crystal display 10 is reduced.

### SUMMARY OF THE INVENTION

It is therefore an object of the invention to provide a liquid crystal display, utilizing a barrier in the space, such as a protrusion, to prevent the liquid crystal molecules from having sufficient space to rotate. As a result, the phase or the polarization direction of the incident light are not changed. When the liquid crystal display is improperly assembled or a lateral shear stress is applied thereto, light leakage is therefore avoided, for increasing the aperture ratio of the liquid crystal display and enlarging the range of the view angle of the liquid crystal display.

The invention achieves the above-identified objects by providing a liquid crystal display including the first substrate, the second substrate and a crystal liquid layer. The first substrate includes an active matrix, a control switch, a pixel electrode and a protrusion. The active matrix including a number of pixels is disposed on the first substrate. Each of the pixels is defined by the first scan line, the second scan line adjacent to the first scan line, the first data line and the second data line adjacent to the first data line on the first substrate. The control switch is disposed inside the pixel and electrically connected with the first scan line and the first data line. The pixel electrode is disposed inside the pixel and electrically connected with the control switch. The protrusion is disposed between the pixel electrode and the first data line, and/or between the pixel electrode and the second data line, and/or between the pixel electrode and the first scan line, and/or between the pixel electrode and the second scan line. The second substrate is disposed above the first substrate. The liquid crystal layer is disposed between the first substrate and the second substrate.

The invention achieves the above-identified objects by providing another liquid crystal display including the first substrate, the second substrate and a liquid crystal layer. The first substrate includes an active matrix, a control switch and a pixel electrode. The active matrix including a number of pixels is disposed on the first substrate. Each of the pixels is defined by the first scan line, the second scan line adjacent to the first scan line, the first data line and the second data line adjacent to the first data line on the first substrate. The control switch is disposed inside the pixel and electrically connected with the first scan line and the first data line. The pixel electrode is disposed inside the pixel and electrically connected with the control switch. The second substrate including a black matrix, a color filter and a protrusion is disposed above the first substrate. The black matrix corresponds to the active matrix and exposes a main portion of the pixel electrode. The color filter overlaps part of the peripheral of the black matrix and corresponds to the main portion of the pixel electrode exposed by the black matrix. The protrusion is disposed above an overlap of the color filter and the black matrix, or above the black matrix and being adjacent to the overlap. The liquid crystal layer is disposed between the first substrate and the second substrate.

The protrusion described above is disposed along a direction substantially parallel to the first scan line and/or the second scan line and/or the first data line and/or the second data line. Moreover, the protrusion can be continuous or discontinuous. Furthermore, the protrusion is selected from the group consisting of photospacers, photoresists, and polymers.

The invention achieves the above-identified objects by providing still another liquid crystal display, including the first substrate, the second substrate and a liquid crystal layer. The first substrate includes an active matrix, a control switch, a pixel electrode and the first protrusion. The active matrix including a number of pixels is disposed on the first substrate. Each of the pixels is defined by the first scan line, the second scan line adjacent to the first scan line, the first data line and the second data line adjacent to the first data line on the first substrate. The control switch is disposed inside the pixel and electrically connected with the first scan line and the first data line. The pixel electrode is disposed inside the pixel and electrically connected with the control switch. The first protrusion is disposed between the pixel electrode and the first data line, and/or between the pixel electrode and the second data line, and/or between the pixel electrode and the first scan line, and/or the pixel electrode and the second scan line. The second substrate including a black matrix, a color filter and the second protrusion is disposed above the first substrate. The black matrix corresponds to the active matrix and exposes a main portion of the pixel electrode. The color filter overlapping part of the peripheral of the black matrix corresponds to the main portion of the pixel electrode exposed by the black matrix. The second protrusion is disposed above an overlap where the color filter partly overlaps the black matrix, or above the black matrix and being adjacent to the overlap. The liquid crystal layer is disposed between the first substrate and the second substrate.

The first protrusion and the second protrusion described above are disposed along a direction substantially parallel to the first scan line, and/or the second scan line, and/or the first data line, and/or the second data line. Moreover, the first protrusion and the second protrusion can be continuous or discontinuous. Furthermore, the first protrusion and the second protrusion are selected from the group consisting of photospacer, photoresist, polymer and the combination thereof.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Related Art) illustrates part of an electrical circuit layout of a conventional liquid crystal display;

FIG. 1B (Related Art) illustrates part of an enlarged cross-sectional view of the liquid crystal display taken along the line 1B-1B′;

FIG. 1C (Related Art) illustrates part of the enlarged cross-sectional view of the liquid crystal display in FIG. 1B improperly assembled or applied to a lateral shear stress;

FIG. 2A illustrates part of an electrical circuit layout of a liquid crystal display according to the first embodiment of the invention;

FIG. 2B illustrates part of an enlarged cross-sectional view of the liquid crystal display taken along the line 2B-2B′;

FIG. 2C illustrates part of the enlarged cross-sectional view of the liquid crystal display in FIG. 2B improperly assembled or applied to a lateral shear stress;

FIG. 3A illustrates part of an electrical circuit layout in a liquid crystal display of the second embodiment of the invention;

FIG. 3B illustrates part of an enlarged cross-sectional view of the liquid crystal display taken along the line 3B-3B′;

FIG. 3C illustrates part of the enlarged cross-sectional view of the liquid crystal display in FIG. 3B improperly assembled or applied to a lateral shear stress;

FIG. 4A illustrates part of an electrical circuit layout of a liquid crystal display according to the third embodiment of the invention;

FIG. 4B illustrates part of an enlarged cross-sectional view of the liquid crystal display taken along the line 4B-4B′; and

FIG. 4C illustrates part of the enlarged cross-sectional view of the liquid crystal display in FIG. 4B improperly assembled or applied to a lateral shear stress.

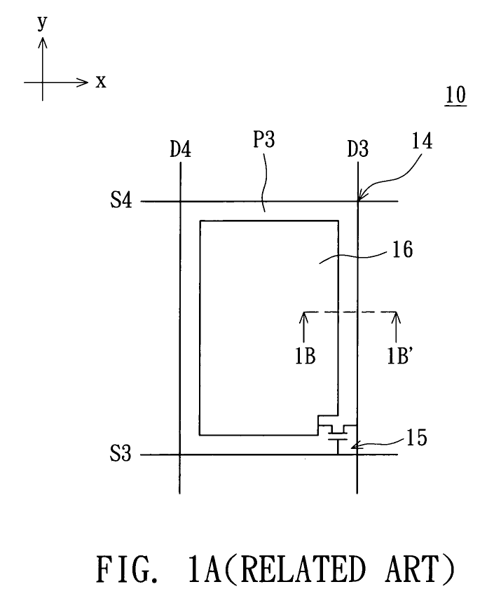

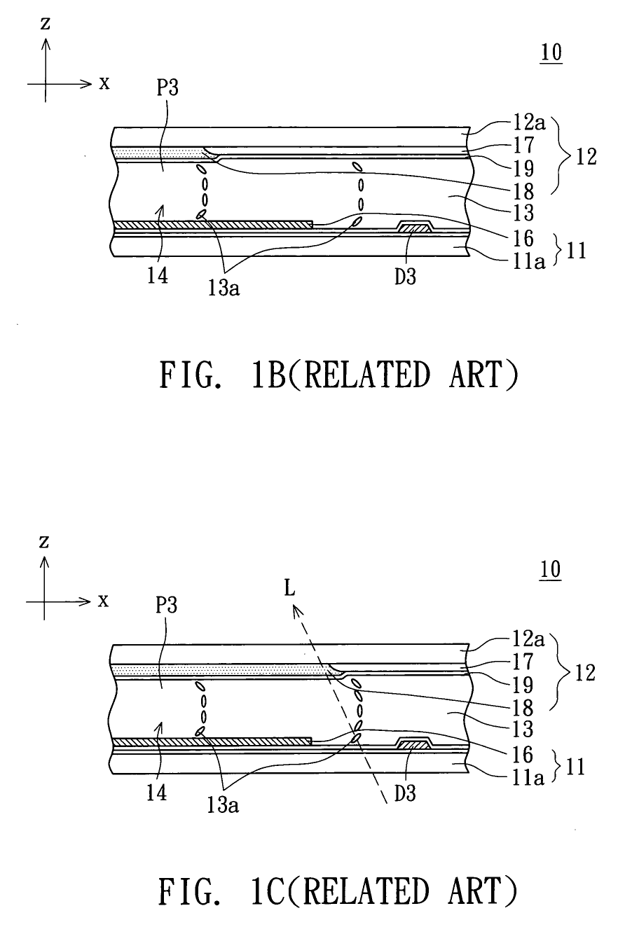

### DETAILED DESCRIPTION OF THE INVENTION

A liquid crystal display (LCD) with a protrusion disposed between the pixel electrode and scan lines, and/or between the pixel electrode and the data lines is provided. Therefore, some of the liquid crystal molecules between the substrate and the protrusion can't rotate due to insufficient space and the phase or the polarization direction of the incident light are not changed. As a result, light leakage of the liquid crystal display, occurring when the liquid crystal display is improperly assembled or is applied to a shear stress, is avoided. Accordingly, the aperture ratio of the liquid crystal display is increased, and the range of the view angle of the liquid crystal display is enlarged. The position of the protrusion and the forming method thereof are illustrated as follows.

### First Embodiment

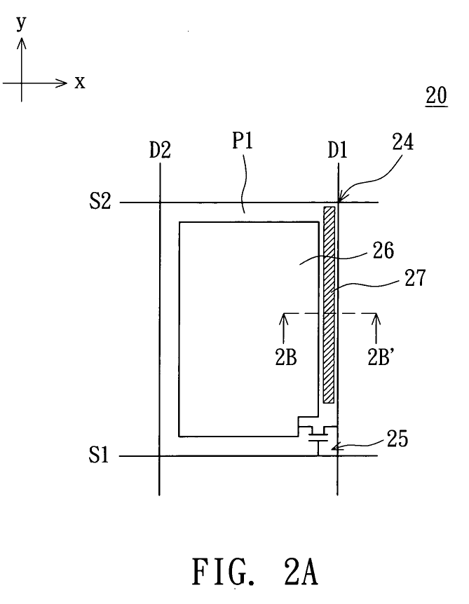

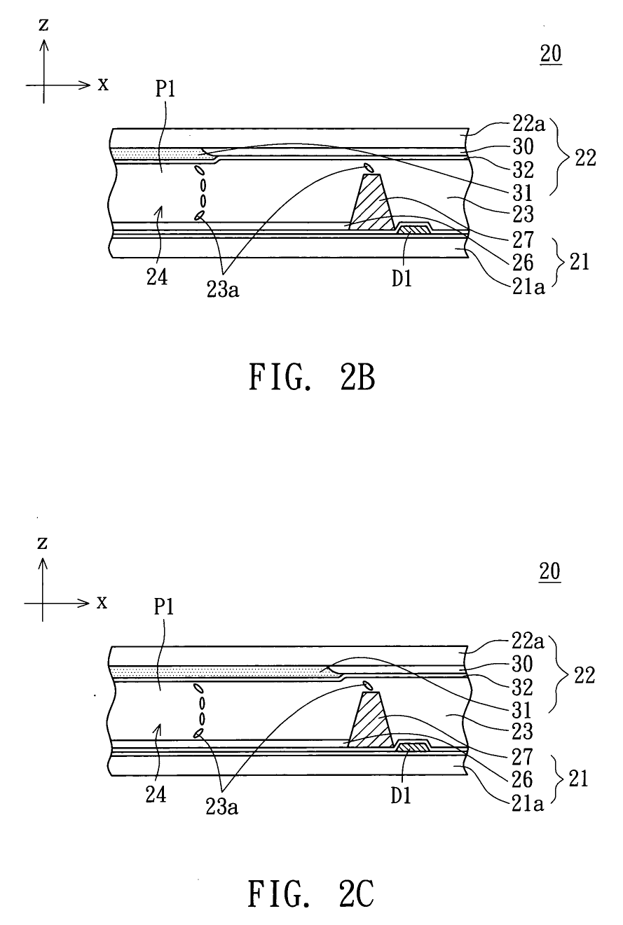

Please referring to FIG. 2A˜2B, FIG. 2A illustrates part of an electrical circuit layout of a liquid crystal display according to the first embodiment of the invention, and FIG. 2B illustrates part of an enlarged cross-sectional view of the liquid crystal display taken along the line 2B-2B′. In FIG. 2A˜2B, a liquid crystal display 20 includes the first substrate 21, the second substrate 22 and a liquid crystal layer 23. The second substrate 22 is disposed above the first substrate 21. The liquid crystal layer 23 having a number of liquid crystal molecules 23a is disposed between the first substrate 21 and the second substrate 22.

The first substrate 21 includes the first base 21a, an active matrix 24, at least a control switch 25, at least a pixel electrode 26, and at least a protrusion 27. The active matrix 24 including a number of pixels is disposed on the first base 21a of the first substrate 21. Two adjacent scan lines and two adjacent data lines are disposed on the first base 21a of the first substrate 21. Each of the pixels is defined by two adjacent scan lines crossing with two adjacent data lines. In other word, the two adjacent scan lines are perpendicularly crossed to the two adjacent data lines. In the liquid crystal display 20 of the present embodiment of the invention, the active matrix 24 including a pixel P1 is illustrated. The pixel P1 is defined by crossing the first scan line S1 and the adjacent second scan line S2 with the first data line D1 and the adjacent second data line D2. The control switch 25 is disposed inside the pixel P1 by being positioned on the first base 21a. The control switch 25 is electrically connected with the first scan line S1 and the first data line D1. The control switch 25 can be a transistor or other electrical element, such as a thin film transistor (TFT). The pixel electrode 26 is disposed inside the pixel P1 by being positioned on the first base 21a. The pixel electrode 26 electrically connected with control switch 25 can be a transparent electrode, such as an indium tin oxide (ITO) electrode.

The protrusion can be disposed between the pixel electrode 26 and the first data line D1, and/or between the pixel electrode 26 and the second data line D2, and/or between the pixel electrode 26 and the first scan line S1, and/or between the pixel electrode 26 and the second scan line S2. In other words, the protrusion can be disposed on any region between the pixel electrode 26, the first scan line S1, the second scan line S2, the first data line D1, and the second line D2.

In the liquid crystal liquid display 20 of the present embodiment of the invention, the I-shaped protrusion 27 is disposed between the pixel electrode 26 and the first data line D1. The protrusion 27 can extend above the control switch 25. A distance between the protrusion 27 and the second substrate 22 is smaller than a cell gap between the first substrate 21 and the second substrate 22, as shown in FIG. 2B.

The position and the shape of the protrusion are illustrates as follows. When the protrusion is disposed between the pixel electrode 26 and the first scan line S1, and between the pixel electrode 26 and the first data line D1, the protrusion is L-shaped. When the protrusion is disposed between the pixel electrode 26 and the first scan line S1, between the pixel electrode 26 and the first data line D1, and between the pixel electrode 26 and the second scan line S2, the protrusion is U-shaped. When the protrusion is disposed between the pixel electrode 26 and the first scan line S1, between the pixel electrode 26 and the first data line D1, between the pixel electrode 26 and the second scan line S2, and between the pixel electrode 26 and the second data line D2, the shape of the protrusion is like a rectangular ring. However, the position and the shape of the protrusion are not limited to the above examples.

As shown in FIG. 2C, the protrusion 27 between the first substrate 21 and the second substrate 22 acts as a barrier in the space of the liquid crystal layer 23. Therefore, when the first substrate 21 and the second substrate 22 is improperly assembled or a lateral shear stress (such as a lateral stress along the X-coordinate) is applied thereto, light leakage is avoided in liquid crystal display 20 because some of the liquid crystal molecules 23a between the second substrate 22 and the protrusion 27 can not rotate due to insufficient space, and the phase or the polarization direction of the incident light are not changed. Accordingly, the aperture ratio of the liquid crystal display 20 is increased, and the range of view angle of the liquid crystal display 20 is enlarged.

However, anyone who has ordinary skill in the field of the present embodiment of the invention can understand that the invention is not limited thereto. For example, the first base 21a and the second base 22a can be glass substrates, transparent plastic substrates and transparent insulating substrates. Moreover, although the protrusion 27 is a continuous strip in the liquid crystal display 20 of the embodiment of the invention, the protrusion can be a discontinuous strip or be in other discontinuous shape as well. Furthermore, the protrusion 27 or the protrusion in other shape as described above can be selected from the group consisting of photospacer, photoresist, polymer and the combination thereof. In the liquid crystal display 20 of the embodiment of the invention, as shown in FIG. 2B˜2C, the second substrate 22 includes the second base 22a, a black matrix 30, a color filter 31 and a common electrode 32. The black matrix 30 corresponds to the active matrix 24 by being positioned on the second base 22a and exposes a main portion of the pixel electrode 26. The color filter 31 overlaps part of the peripheral of the black matrix 30 by being positioned on the second base 22a. For example, the peripheral of the color filter 31 covers that of the black matrix 30. The color filter 31 corresponds to the main portion of the pixel electrode 26 exposed by the black matrix 30. The common electrode 32 is disposed on the color filter 32 and the black matrix 21, for generating an electric field along with the pixel electrode 26 to control the orientation of the liquid crystal molecules 23a. The common electrode 32 can be a transparent electrode, such as an ITO electrode. The first substrate 21 and the second substrate 22 can be a thin film transistor substrate and a color filter substrate respectively. The color filter 31 includes red (R) color filter, green (G) color filter and blue (B) color filter.

### Second Embodiment

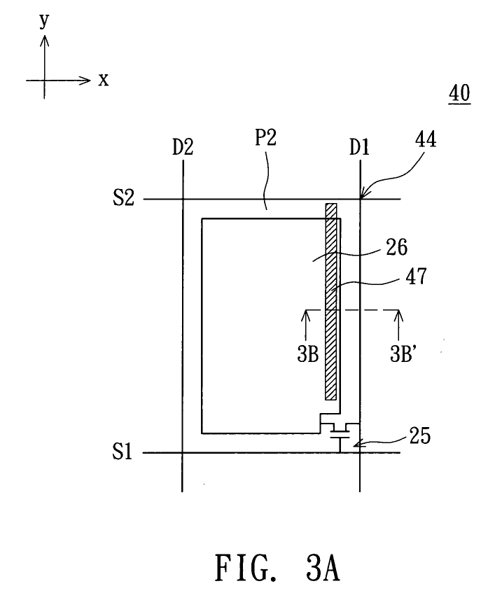

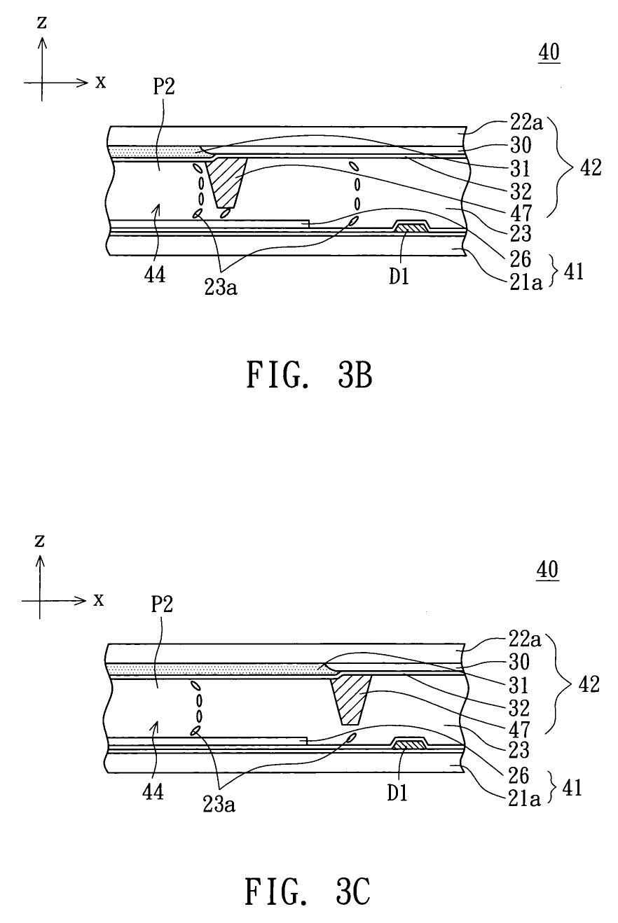

Please referring to FIG. 3A˜3B, FIG. 3A illustrates part of an electrical circuit layout in a liquid crystal display according to the second embodiment of the invention, and FIG. 3B illustrates part of an enlarged cross-sectional view of the liquid crystal display taken along the line 3B-3B′. The differences between the liquid crystal display 40 of the present embodiment of the invention and the liquid crystal display 20 of the first embodiment of the invention are the first substrate 41, the second substrate 42 and the position of a protrusion 47. The same other elements using the same reference numbers are not described redundantly. In FIG. 3A˜3B, the liquid crystal display 40 includes the first substrate 41, the second substrate 42 and a liquid crystal layer 23. The second substrate 42 is disposed above the first substrate 41. The liquid crystal layer 23 having a number of liquid crystal molecules 23a is disposed between the first substrate 41 and the second substrate 42.

The first substrate 41 includes the first base 21a, an active matrix 44, at least a control switch 25 and at least a pixel electrode 26. The active matrix 44 including a number of pixels is disposed on the first base 21a of the first substrate 41. Two adjacent scan lines and two adjacent data lines are disposed on the first base 21a of the first substrate 21. Each of the pixels is defined by two adjacent scan lines crossing with two adjacent data lines. In other words, the two adjacent scan lines are perpendicularly crossed to the two adjacent data lines. In the liquid crystal display 40 of the present embodiment of the invention, the active matrix 44 having a pixel P2 is illustrated. The pixel P2 is defined by the first scan line S1 and the adjacent second scan line S2 crossing with the first data line D1 and the adjacent second data line D2. The disposition of the control switch 25 and the pixel electrode 26 inside the pixel P2 is the same with the disposition of the control switch 25 and the pixel electrode 26 inside the pixel P1 and thus is not described redundantly.

The second substrate 42 includes the second base 22a, a black matrix 30, a color filter 31, a common electrode 32 and at least a protrusion 47. The dispositions of the black matrix 30, the color filter 31 and the common electrode 32 on the second base 22a in the liquid crystal display 40 are the same with those in the liquid crystal display 20, and thus are not described redundantly.

The protrusion is disposed on the common electrode 32. Moreover, the protrusion can be disposed above an overlap where the color filter 31 partly overlaps the black matrix 30, or above the black matrix 30 and be adjacent to the overlap where the color filter 31 partly overlaps the black matrix 30. The protrusion corresponds a side of the pixel electrode 26 which is adjacent to the first data line D1, and/or a side of the pixel electrode 26 which is adjacent to the second data line D2, and/or a side of the pixel electrode 26 which is adjacent to the first scan line S1, and/or a side of the pixel electrode 26 which is adjacent to the second scan line S2. The protrusion can be L-shaped, U-shaped or like a rectangular ring.

The protrusion 47 is disposed above the black matrix 30 and is adjacent to the overlap where the color filter 31 partly overlaps the black matrix 30. The protrusion 47 corresponds to the side of the pixel electrode 26 which is adjacent to the first data line D1. The protrusion 47 is I-shaped. As shown in FIG. 3B, a distance between the protrusion 47 and the first substrate 41 is smaller than a cell gap between the first substrate 41 and the second substrate 42.

The position and the shape of the protrusion are illustrated as follows. When the protrusion corresponds to the side of the pixel electrode 26 which is adjacent to the first data line D1 and the side of the pixel electrode 26 which is adjacent to the first scan line S1, the protrusion is L-shaped. When the protrusion corresponds to the side of the pixel electrode 26 which is adjacent to the first data line D1, the side of the pixel electrode 26 which is adjacent to the second data line D2, and the side of the pixel electrode 26 which is adjacent to the first scan line S1, the protrusion is U-shaped. When the protrusion corresponds to the side of the pixel electrode 26 which is adjacent to the first data line D1, the side of the pixel electrode 26 which is adjacent to the second data line D2, the side of the pixel electrode 26 which is adjacent to the first scan line S1, and the side of the pixel electrode 26 which is adjacent to the second scan line S2, the shape of the protrusion is like a rectangular ring. However, the position and the shape of the protrusion are not limited to the above examples.

As shown in FIG. 3C, the protrusion 47 between the first substrate 41 and the second substrate 42 acts as a barrier in the space of the liquid crystal layer 23. When the first substrate 41 and the second substrate 42 is improperly assembled or a shear stress (such as a lateral shear stress along the X-coordinate) is applied thereto, light leakage is avoided in the liquid crystal display 40 because some of the liquid crystal molecules 23a between the first substrate 41 and protrusion 47 can not rotate due to insufficient space, and the phase or the polarization direction of the incident light are not changed. Therefore, the aperture ratio of the liquid crystal display 40 is increased, and the range of the view angle of the liquid crystal display 40 is enlarged.

However, anyone who has ordinary skill in the field of the present embodiment of the invention can understand that the invention is not limited thereto. For example, the first substrate 41 and the second substrate 42 can be a thin film transistor substrate and a color filter substrate respectively. Although the protrusion 47 is a continuous strip in the liquid crystal display 40, the protrusion can be a discontinuous strip as well. Moreover, the protrusion 47 can be selected from the group consisting of photospacer, photoresist, polymer and the combination thereof.

### Third Embodiment

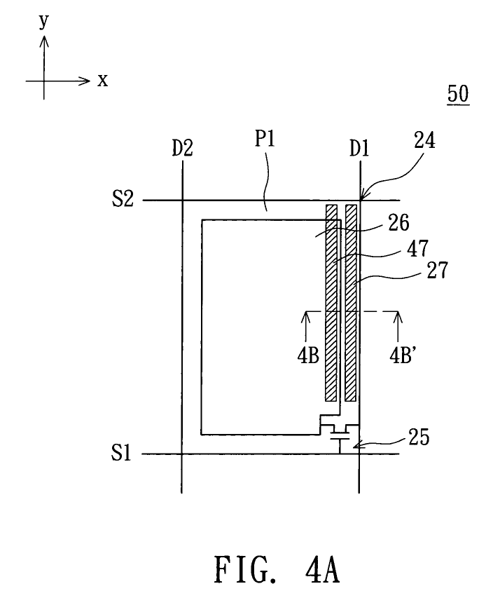

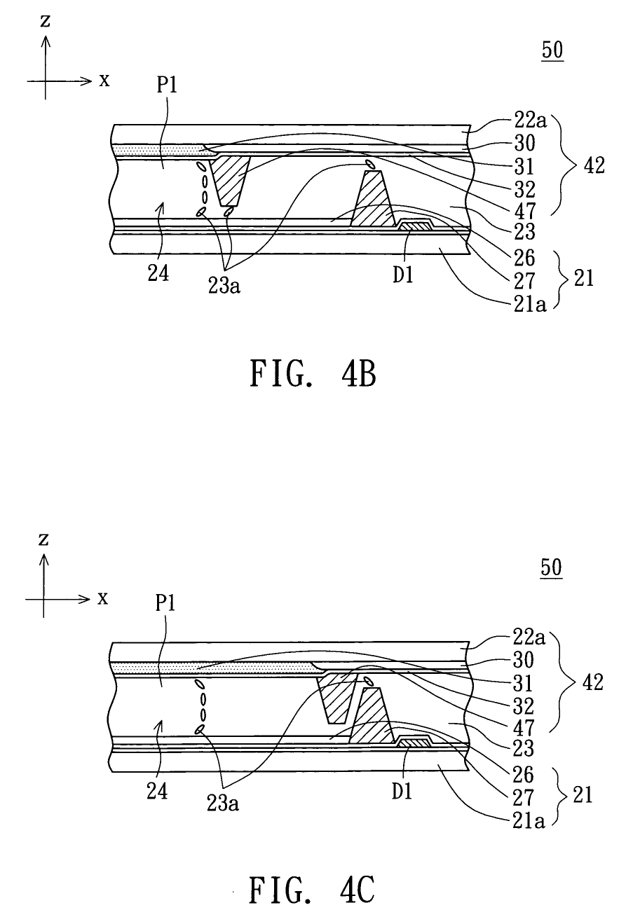

Please referring to FIG. 4A˜4B, FIG. 4A illustrates part of an electrical circuit layout of a liquid crystal display according to the third embodiment of the invention, and FIG. 4B illustrates part of an enlarged cross-sectional view of the liquid crystal display taken along the line 4B-4B′. The differences between the liquid crystal display 50 of the present embodiment of the invention and the liquid crystal display 20 of the first embodiment of the invention are the second substrate 42 and the protrusion 47. The second substrate 42 and the protrusion 47 are already disclosed in the liquid crystal display 40 in the second embodiment of the invention. As to the same other elements, the same reference numbers are used and not described redundantly.

The protrusion disposed on the first substrate 21 can be disposed between the pixel electrode 26 and the first data line D1, and/or between the pixel electrode 26 and the second data line D2, and/or between the pixel electrode 26 and the first scan line S1, and/or between the pixel electrode 26 and the second scan line S2. Moreover, the protrusion disposed on the second substrate 42 can be disposed on the common electrode 32, above an overlap where the color filter 31 partly overlaps the black matrix 30, or above the black matrix 30 and be adjacent to the overlap where the color filter 31 partly overlaps the black matrix 30. The protrusion corresponds a side of the pixel electrode 26 which is adjacent to the first data line D1, and/or a side of the pixel electrode 26 which is adjacent to the second data line D2, and/or a side of the pixel electrode 26 which is adjacent to the first scan line S1, and/pr a side of the pixel electrode 26 which is adjacent to the second scan line S2.

As shown in FIG. 4C, the protrusions 27 and 47 between the first substrate 21 and the second substrate 42 act as barriers in the space of the liquid crystal layer 23. Therefore, when the first substrate 21 and the second substrate 42 is improperly assembled or a lateral shear stress (such as a lateral shear stress along the X-coordinate) is applied thereto, light leakage is avoided in the liquid crystal display 50 because some of the molecules 23a between the first substrate 21 and the protrusion 47 and between the second substrate 42 and the protrusion 27 can not rotate due to insufficient space, and the phase and the polarization direction of the incident light are not changed. Accordingly, the aperture ratio of the liquid crystal display 50 is increased, and the range of the view angle of the liquid crystal display 50 is enlarged.

However, anyone who has ordinary skill in the field of the present embodiment of the invention can understand that the invention is not limited thereto. For example, the protrusions 27 and 47 can be references when the first substrate 21 and the second substrate 42 are assembled. If the protrusions 27 and 47 interfere with each other, it means that the first substrate 21 and the second substrate 42 are improperly assembled. The operator can be reminded to reassemble the first substrate 21 and the second substrate 42. Therefore, the possibility of improper assembly of the liquid crystal display is lowered. Furthermore, the thickness of the protrusions 27 and 47 can be smaller than the cell gap between the first substrate 21 and the second substrate 42. The protrusions 27 and 47 do not interfere with each other when the first substrate 21 and the second substrate 42 are assembled improperly. But the protrusions 27 and 47 can still prevent some of the liquid crystal molecules 23a between the first substrate 21 and the protrusion 47, between the second substrate 42 and the protrusion 27, and between the protrusions 27 and 47 from having sufficient space to rotate. As a result, the phase and the polarization direction of the incident light are not changed.

The liquid crystal displays described in the embodiments of the invention utilize a barrier in the space, as a protrusion, to fill the space of the light leakage. Therefore, some of the liquid crystal molecules between the substrates and the protrusion do not have sufficient space to rotate, and the phase and the polarization of the incident light are not changed. When the liquid crystal display is improperly assembled or a lateral shear stress is applied thereto, the light leakage is avoided. Accordingly, the aperture ratio of the liquid crystal display is increased, and the range of the liquid crystal display is enlarged.

While the invention has been described by way of example and in terms of embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display (LCD), comprising:
a first substrate, comprising:
an active matrix having a plurality of pixels disposed on the first substrate, wherein each of the pixels is defined by a first scan line, a second scan line adjacent to the first scan line, a first data line and a second data line adjacent to the first data line disposed on the first substrate;
a control switch disposed inside the pixel and electrically connected with the first scan line and the first data line;
a pixel electrode disposed inside the pixel and electrically connected with the control switch; and
a protrusion disposed between the pixel electrode and the first data line, and/or between the pixel electrode and the second data line, and/or between the pixel electrode and the first scan line, and/or between the pixel electrode and the second scan line;
a second substrate disposed above the first substrate; and
a liquid crystal layer disposed between the first substrate and the second substrate.

2. The liquid crystal display according to claim 1, wherein the control switch is a transistor.

3. The liquid crystal display according to claim 2, wherein the control switch is a thin film transistor (TFT).

4. The liquid crystal display according to claim 1, wherein the protrusion is disposed along a direction substantially parallel to the first scan line, and/or the second scan line, and/or the first data line, and/or the second data line.

5. The liquid crystal display according to claim 1, wherein the protrusion is continuous or discontinuous.

6. The liquid crystal display according to claim 1, wherein the protrusion is selected from the group consisting of photospacer, photoresist, polymer and the combination thereof.

7. A liquid crystal display (LCD), comprising:
a first substrate, comprising:
an active matrix having a plurality of pixels disposed on the first substrate, wherein each of the pixels is defined by a first scan line, a second scan line adjacent to the first scan line, a first data line and a second data line adjacent to the first data line disposed on the first substrate;
a control switch disposed inside the pixel and electrically connected with the first scan line and the first data line; and
a pixel electrode disposed inside the pixel and electrically connected with the control switch;
a second substrate disposed above the first substrate, comprising:
a black matrix corresponding to the active matrix for exposing a main portion of the pixel electrode;
a color filter overlapping part of the peripheral of the black matrix and corresponding to the main portion of the pixel electrode exposed by the black matrix; and
a protrusion disposed above an overlap of the color filter and the black matrix, or above the black matrix and being adjacent to the overlap; and
a liquid crystal layer disposed between the first substrate and the second substrate.

8. The liquid crystal display according to claim 7, wherein the control switch is a transistor.

9. The liquid crystal display according to claim 8, wherein the control switch is a thin film transistor (TFT).

10. The liquid crystal display according to claim 7, wherein the protrusion is disposed along a direction substantially parallel to the first scan line, and/or the second scan line, and/or the first data line, and/or the second data line.

11. The liquid crystal display according to claim 7, wherein the protrusion is continuous or discontinuous.

12. The liquid crystal display according to claim 7, wherein the protrusion is selected from the group consisting of photospacer, photoresist, polymer and the combination thereof.

13. A liquid crystal display (LCD), comprising:
a first substrate, comprising:
an active matrix having a plurality of pixels disposed on the first substrate, wherein each of the pixels is defined by a first scan line, a second scan line adjacent to the first scan line, a first data line and a second data line adjacent to the first data line disposed on the first substrate;
a control switch disposed inside the pixel and electrically connected with the first scan line and the first data line;
a pixel electrode disposed inside the pixel and electrically connected with the control switch; and
a first protrusion disposed between the pixel electrode and the first data line, and/or between the pixel electrode and the second data line, and/or between the pixel electrode and the first scan line, and/or between the pixel electrode and the second scan line;
a second substrate disposed above the first substrate, comprising:
a black matrix corresponding to the active matrix and exposing a main portion of the pixel electrode;
a color filter overlapping part of the peripheral of the black matrix and corresponding to the main portion of the pixel electrode exposed by the black matrix; and
a second protrusion disposed above an overlap where the color filter partly overlaps the black matrix, or above the black matrix and being adjacent to the overlap; and
a liquid crystal layer disposed between the first substrate and the second substrate.

14. The liquid crystal display according to claim 13, wherein the control switch is transistor.

15. The liquid crystal display according to claim 14, wherein the control switch is a thin film transistor (TFT).

16. The liquid crystal display according to claim 13, wherein the first protrusion is disposed along a direction substantially parallel to the first scan line, and/or the second scan line, and/or the first data line, and/or the second data line.

17. The liquid crystal display according to claim 13, wherein the first protrusion is continuous or discontinuous.

18. The liquid crystal display according to claim 13, wherein the first protrusion is selected from the group consisting of the photospacer, photoresist, polymer and the combination thereof.

19. The liquid crystal display according to claim 13, wherein the second protrusion is continuous or discontinuous.

20. The liquid crystal display according to claim 13, wherein the second protrusion is selected from the group consisting of photospacer, photoresist, polymer and the combination thereof.
